(19) United States
(12) Patent Application Publication
(10) Pub. No.: US 2025/0019965 A1
(43) Pub. Date: Jan. 16, 2025

(54) SYSTEM AND METHOD FOR RETROFITTING A STRUCTURE USING PANEL BLOCKS

(71) Applicants: Trustees of Boston University, Boston, MA (US); Fraunhofer USA, Inc., Plymouth, MI (US)

(72) Inventors: Andre Sharon, Newton, MA (US); John Charles Briggs, Brookline, MA (US); Aaron Sharpe, Brookline, MA (US); Kurt Roth, Brookline, MA (US); Harry Clair Fennell, JR., North Thetford, VT (US)

(73) Assignees: Trustees of Boston University, Boston, MA (US); Fraunhofer USA, Inc., Plymouth, MI (US)

(21) Appl. No.: 18/712,173

(22) PCT Filed: Nov. 23, 2022
(86) PCT No.: PCT/US2022/050841

§ 371 Date: May 21, 2024

Related U.S. Application Data
(60) Provisional application No. 63/282,430, filed on Nov. 23, 2021.
(60) Provisional application No. 63/282,437, filed on Nov. 23, 2021.

(51) Int. Cl. E04C 2/24; E04C 2/288; E04C 2/292

(52) U.S. Cl. CPC E04C 2/243; E04C 2/288; E04C 2/292

(57) ABSTRACT

A panel block for retrofitting a structure is provided. The panel block includes a plurality of foam blocks for insulation. Each of the foam blocks includes a first feature and a second feature. The first feature and the second feature are configured to interlock adjacent panel blocks. A protective cladding layer is positioned on one of the foam blocks.

### RELATED APPLICATIONS

This application claims priority to U.S. provisional application No. 63/282,430, filed on Nov. 23, 2021, and U.S. provisional application No. 63/282,437, filed on Nov. 23, 2021, their contents of which are included herein in their entirety.

### GOVERNMENT LICENSE RIGHTS

This invention was made with government support under contract number DE-EE0009066. The government has certain rights in the invention.

### BACKGROUND

Home retrofits have been targeted as an area of great potential for significant energy savings, employment opportunities, and market growth. However, the barriers to the widespread adoption of comprehensive retrofit strategies remain high. These barriers include the cost of retrofitting and the time it takes complete these retrofits.

There is a need to improve the home retrofitting process using panel blocks and augmented reality.

### SUMMARY

According to one aspect of the subject matter described in this disclosure, a panel block for retrofitting a structure is provided. The panel block includes a plurality of foam blocks for insulation. Each of the foam blocks includes a first feature and a second feature. The first feature and the second feature are configured to interlock adjacent panel blocks. A protective cladding layer is positioned on a surface of one of the foam blocks.

In this panel block, the first feature may include an inner flange and an outer flange. The second feature may include an inner flange and an outer flange. The inner flange and the outer flange of the first feature interacts with the inner flange and the outer flange of the second feature of at least one of the adjacent panel blocks to form a seal when interlocked. The first feature may provide mechanical support to the inner flange of the second feature of at least one of the adjacent panel blocks. The first feature may be configured to receive a screw. The outer flange of the second feature of at least one of the adjacent blocks hides the screw from view. The inner flange and the outer flange of the first feature may be asymmetric. The outer flange of the first feature is lower than the inner flange of the first feature. The protective cladding layer may include a U-shape structure that clips on a protruding section of one of the foam blocks.

In this panel block, the protective cladding layer may include aluminum. The protective cladding layer may include wood. The protective cladding layer may include a synthetic material with the appearance of wood. The protective cladding layer may include a moldable material. The moldable material may include an appearance of bricks. The moldable material may include an appearance of stones. The moldable material comprises an appearance of stucco. The protective cladding layer may include stucco. Each of the foam blocks may be staggered relative to each other.

According to another aspect of the subject matter described in this disclosure, a method for manufacturing a panel block is provided. The method includes forming a plurality of foam blocks for insulation. Also, the method includes arranging each of the foam blocks to be positioned relative to each other. Each of the foam blocks includes a first feature and a second feature. The first feature and the second feature are configured to interlock adjacent panel blocks. Moreover, the method includes positioning a protective cladding layer on a surface of one of the foam blocks.

In this method, the first feature may include an inner flange and an outer flange. The second feature may include an inner flange and an outer flange. Arranging each of the foam blocks may include interacting the inner flange and the outer flange of the first feature with the inner flange and the outer flange of the second feature of at least one of the adjacent panel blocks to form a seal when interlocked. Arranging each of the foam blocks may include providing, using the first feature, mechanical support to the inner flange of the second feature of at least one of the adjacent panel blocks. Arranging each of the foam blocks may include receiving, from the first feature, a screw. Arranging each of the foam blocks may include hiding, using the outer flange of the second feature of at least one of the adjacent panel blocks. The outer flange of the first feature may be lower than the inner flange of the first feature. The protective cladding layer may include a U-shape structure that clips on a protruding section of one of the foam blocks.

In this method, the protective cladding layer may include aluminum. The protective cladding layer may include wood. The protective cladding layer may include a synthetic material with the appearance of wood. The protective cladding layer may include a moldable material. The moldable material may include an appearance of bricks. The moldable material may include an appearance of stones. The moldable material may include an appearance of stucco. The protective cladding layer may include stucco. Each of the foam blocks may be staggered relative to each other.

According to another aspect of the subject matter described in this disclosure, a method for installing panel blocks is provided. The method includes the following: performing a digital scan of a structure to produce a digital representation of the structure; translating the digital representation of the structure into a building information model (BIM); determining, using the BIM model, an optimal set of data for each of the panel blocks to clad the structure; generating, using the optimal set of data, an installation order for cladding the structure and a fabrication specification for creating the panel blocks to a manufacturer; and implementing, using the digital scan, the optimum set of data, and the installation order, an augmented reality (AR) installation process guiding a user to install at least one of the manufactured panel blocks.

In this method, the digital scan may include a scanned three-dimensional image of the structure. The digital representation may be point cloud data. The BIM may include position, dimension, and orientation of the structure. Translating the digital representation of the structure may include converting the point cloud data into the BIM. Determining the optimal set of data may include utilizing a panelization tool to determine the optimal set of standard and custom panel blocks to fully clad the structure.

In this method, utilizing the panelization tool may include creating a cut list of standard and custom panel blocks that need to be manufactured. Determining the optimal set of data may include utilizing a linear programming multi-objective optimization algorithm to maximize material efficiency and minimize installed costs subjected to specific aesthetic requirements. Generating the installation order may include assigning a unique identifier for each of the panel blocks and generating the installation order for the panel blocks that maximize installation efficiency. Implementing the AR installation process may include utilizing an AR tool to guide an installer through the installation process. The AR tool may include an immersive heads-up display that projects 3D holograms that an operator perceives to be in the real world.

According to another aspect of the subject matter described in this disclosure, a system for installing panel blocks is provided. The system includes one or more computing device processors. One or more computing device memories are coupled to the one or more computing device processors. The one or more computing device memories store instructions executed by the one or more computing device processors, wherein the instructions are configured to: perform a digital scan of a structure to produce a digital representation of the structure; translate the digital representation of the structure into a building information model (BIM); determine, using the BIM model, an optimal set of data for each of the panel blocks and an installation order to clad the structure; generate, using the optimal set of data, generate, using the optimal set of data, an installation order for cladding the structure and a fabrication specification for creating the panel blocks to a manufacturer; and implement, using the digital scan, the optimum set of data, and the installation order, an augmented reality (AR) installation process guiding a user to install at least one of the manufactured panel blocks.

In this system, the digital scan may include a scanned three-dimensional image of the structure. The digital representation is point cloud data. The BIM may include position, dimension, and orientation of the structure. While translating the digital representation of the structure, the instructions may be configured to convert the point cloud data into the BIM. While determining the optimal set of data, the instructions may be configured to utilize a panelization tool to determine the optimal set of standard and custom panel blocks to fully clad the structure. While utilizing the panelization tool, the instructions may be configured to create a cut list of standard and custom panel blocks that need to be manufactured.

In this system, while determining the optimal set of data, the instructions may be configured to utilize a linear programming multi-objective optimization algorithm to maximize material efficiency and minimize installed costs subjected to specific aesthetic requirements. While generating the installation order, the instructions may be configured to assign a unique identifier for each of the panel blocks and generating the installation order for the panel blocks that maximize installation efficiency. While implementing the AR installation process, the instructions may be configured to utilize an AR tool to guide an installer through the installation process. The AR tool may include an immersive heads-up display that projects 3D holograms that an operator perceives to be in the real world.

According to another aspect of the subject matter described in this disclosure, a non-transitory computer-readable storage medium storing instructions which when executed by a computer cause the computer to perform a method for installing panel blocks is provided. The method includes the following: performing a digital scan of a structure to produce a digital representation of the structure; translating the digital representation of the structure into a building information model (BIM); determining, using the BIM model, an optimal set of data for each of the panel blocks to clad the structure; generating, using the optimal set of data, an installation order for cladding the structure and a fabrication specification for creating the panel blocks to a manufacturer; and implementing, using the digital scan, the optimum set of data, and the installation order, an augmented reality (AR) installation process guiding a user to install at least one of the manufactured panel blocks.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram of a retrofitted façade using panel blocks, in accordance with some embodiments.

FIG. 2 is a schematic diagram of a panel block used in retrofitting homes, in accordance with some embodiments.

FIG. 3 is a schematic diagram of a side view of a panel block, in accordance with some embodiments.

FIG. 4 is a schematic diagram of two interlocked panel blocks, in accordance with some embodiments.

FIG. 5 is a detailed schematic diagram of overlapping vinyl cladding layers, in accordance with some embodiments.

FIG. 6 is a flowchart of an installation process of the panel blocks, in accordance with some embodiments.

FIG. 7 is a schematic diagram of a computing system for executing the operations of the installation process of FIG. 6, in accordance with some embodiments.

FIG. 8 is a schematic diagram of staged panel blocks at the installation site.

FIG. 9 is a schematic diagram of a structure being retrofitted with panel blocks.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

A panel block system for home retrofitting and the corresponding installation process are provided in accordance with various embodiments. The panel blocks are configured to be interlocked with adjacent panel blocks allowing for quick assembly over a wall structure or façade. The installation process of the panel blocks is designed to assist installers using immersive augmented reality (AR).

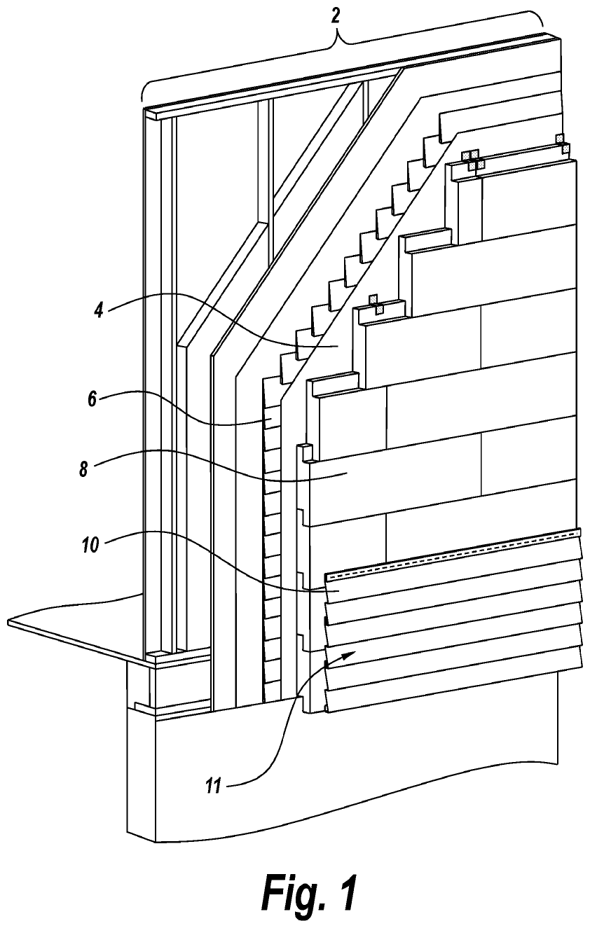

FIG. 1 is a schematic diagram of a retrofitted facade using panel blocks, in accordance with some embodiments. The process for retrofitting façade 2 includes adding a weather-resistive barrier (WRB) 4 over existing façade cladding 6. Panel blocks 11, comprising polyisocyanurate insulation foam 8 and protective cladding 10, are installed directly over WRB 4 which is installed directly of the existing cladding of the façade 2. Also, panel blocks 11 include several foam structures 8 made from polyiso insulation materials or the like.

Each panel block 11 is configured to be interlocked with an adjacent panel block using a tongue and groove feature, which will be discussed further below. This interlocking arrangement makes it easier to install panel blocks on façade 2. Moreover, panel blocks 11 are configured to eliminate fasteners to connect adjacent panel blocks to each other. Also, panel blocks 11 (may have different sizes depending on the construction requirements of façade 2. Other benefits of panel blocks are described below.

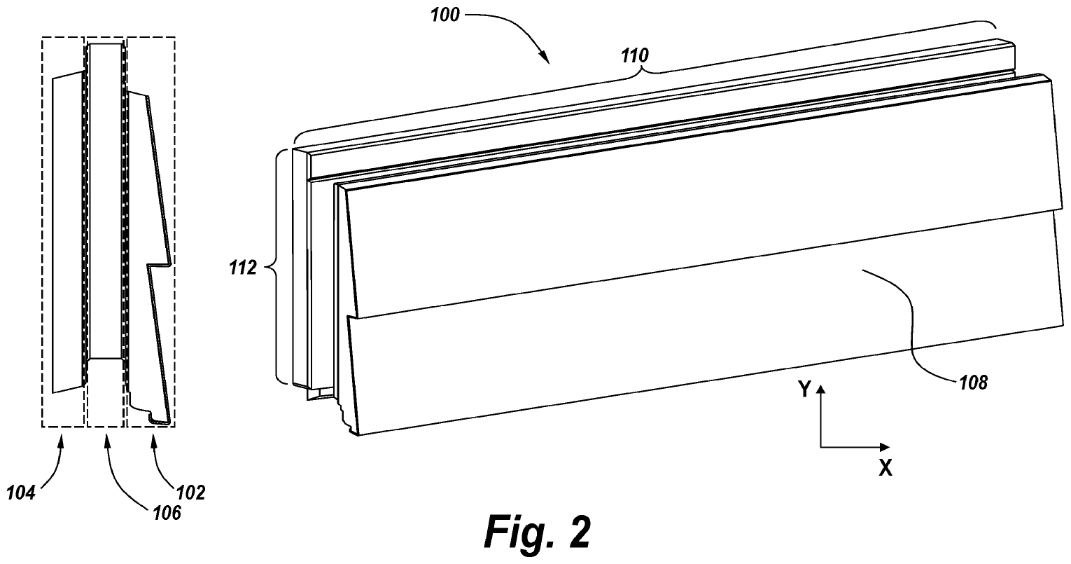

FIG. 2 is a schematic diagram of an example panel block 100 used in retrofitting homes, in accordance with some embodiments. In particular, panel block 100 includes a first portion 102 and a second portion 104. A third portion 106 is positioned between the first portion 102 and the second portion 104. Moreover, panel block 100 includes a protective cladding layer 108, such as vinyl, on the first portion 102. Note first 102, second 104, and third portions 106 are portions of the polyiso foam blocks.

The gap between the first portion 102 and second portion 104 matches the width of third portion 106 to form a tight labyrinth seal. The first portion 102, second portion 104, and third portion 106 are arranged in a staggered configuration to facilitate the labyrinth seal. In particular, the third portion 106 includes a region 110 (tongue) that vertically extends away from first portion 102 and second portion 104, and a region 112 (tongue) that extends horizontally away from first portion 102 and second portion 104. Similarly, the first portion 102 and second portion 104 have a vertically oriented feature on the bottom of the panel block (groove), not visible in FIG. 2 and a horizontally extended feature on the right side of the panel block (groove), also not visible in FIG. 2.

Panel block 100 is designed to interlock with other panel blocks for retrofitting the exterior of a wall or structure. This is described further below. Moreover, panel block 100 may be configured to be of any size and shape to accommodate for various wall structure designs.

In some embodiments, the protective cladding layer 108 may include aluminum. In some embodiments, the protective cladding layer 108 may include wood. In some embodiments, the protective cladding layer 108 may include a synthetic material with the appearance of wood. In some embodiments, the protective cladding layer 108 may include stucco.

In some embodiments, the protective cladding layer 108 may include a moldable material. In some embodiments, the moldable material may include an appearance of bricks. The moldable material may include an appearance of stones. In some embodiments, the moldable material may include an appearance of stucco.

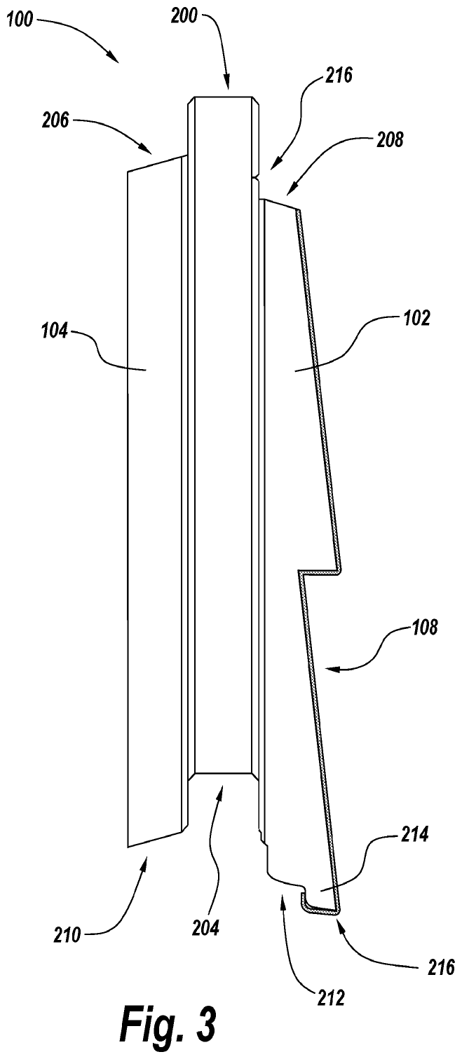

FIG. 3 is a schematic diagram of a side view of example panel block 100, in accordance with some embodiments. In this view, panel block 100 includes tongue feature 200 and groove feature 204. Moreover, panel block 100 includes inner tongue flange 206 and outer tongue flange 208. Inner tongue flange 206 is positioned on the second portion 104 adjacent tongue feature 200. Outer tongue flange 208 is positioned on the first portion 102 adjoining tongue feature 200. Inner groove flange 210 is positioned on the second portion 104 adjoining groove feature 204. Outer groove flange 212 is positioned on the first portion 102 adjacent groove feature 204.

Tongue feature 200 may be region 112, described in FIG. 2. Moreover, a groove feature 204 is configured to be an opening for receiving a tongue feature from another panel block to interlock with panel block 100. Tongue feature 200 and groove feature 204 are formed due to the staggered arrangement of the first portion 102, second portion 104, and third portion 106. Once interlocked, tongue feature 200 and groove feature 204 form a seal. The seal will be discussed further below.

Moreover, tongue inner flange 206 and tongue outer flange 208 may be configured to be sloped so that any water that might enter that space may drain away to either the face of the panel block 100 or to a secondary drain plane behind the panel block 100. First portion 102 includes a protruding section 214 adjacent groove outer flange 212. Cladding layer 108 has a U-shaped feature 216 on the bottom that allows it to clip onto protruding section 214 without needing adhesive or fasteners. In some embodiments, cladding layer may be glued on first portion 102.

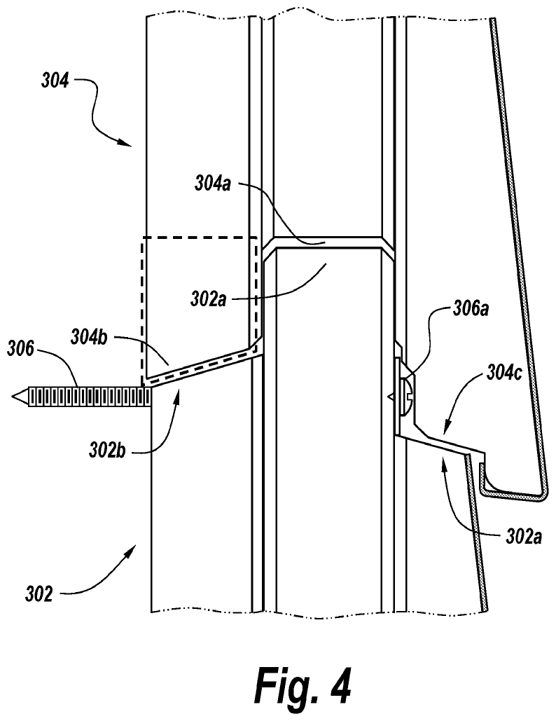

FIG. 4 is a schematic diagram of two example interlocked panels blocks 302 and 304, in accordance with some embodiments. Panel block 302 includes tongue feature 302a, inner tongue flange 302b, and outer tongue flange 302c. Panel block 304 includes groove feature 304a, an inner groove flange 304b, and an outer groove flange 304c. Once panel blocks 302 and 304 are interlocked, a labyrinth seal is formed between the surfaces of tongue feature 302a and groove feature 304a, inner tongue flange 302b and inner grove flange 304b, and outer tongue flange 302c and outer groove flange 304c. This labyrinth seal reduces airflow between panel blocks 302 and 304.

A screw 306 is positioned in tongue feature 302a and extends horizontally to inner flange 302b of panel block 302. The inner groove flange 304b adjacent groove feature 304a is configured to receive mechanical support to inner tongue flange 302b when screw 306 is in position. This mechanical support eliminates the need to use fasteners on the portion of panel block 304 that is adjacent to panel block 302. Moreover, panel blocks 302 and 304 are configured to hide screw head 306a of screw 306 behind outer groove flange 304c of panel block 304.

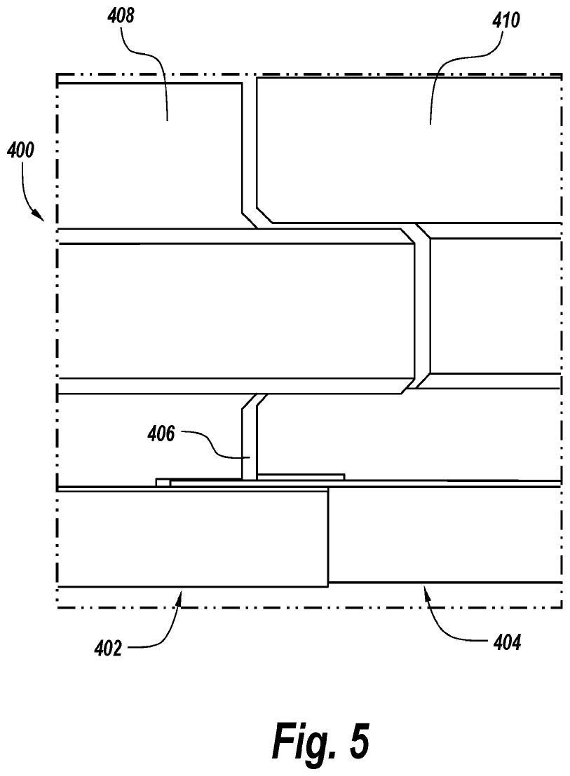

FIG. 5 is a detailed schematic diagram of example overlapping vinyl cladding layers 402 and 404, in accordance with some embodiments. Panel blocks 408 and 410 are interlocked. Panel block 408 includes a vinyl cladding layer 402, and panel block 410 includes a vinyl cladding layer 404. In this case, panel block 408 may allow vinyl cladding layer 402 to be left long on one end so that it overlaps with vinyl cladding layer 404 of panel block 410. The overlapping cladding layers 402 and 404 are configured to eliminate a visual gap 406 between the interlocked panel blocks. The length of the overlaps between vinyl cladding layers 402 and 404 may vary depending on the needs of the facade or wall structure being retrofitted.

Moreover, the installation process for the panel blocks is described below. The installation process combines the residing and building envelope deep energy retrofit (DER) industries together to form a cost competitive alternative to either. Both industries today rely on skilled labor to “customize” all materials on site. They are expensive and often not seen as worth the investment (particularly DER). The integrated approach customizes the necessary components in a factory and ships them to a job site for installation. Performing the net-shape fabrication in an automated digital methodology, customizing all the required components in a controlled factory setting, and using augmented reality to guide the installation process enables cost-effective installation.

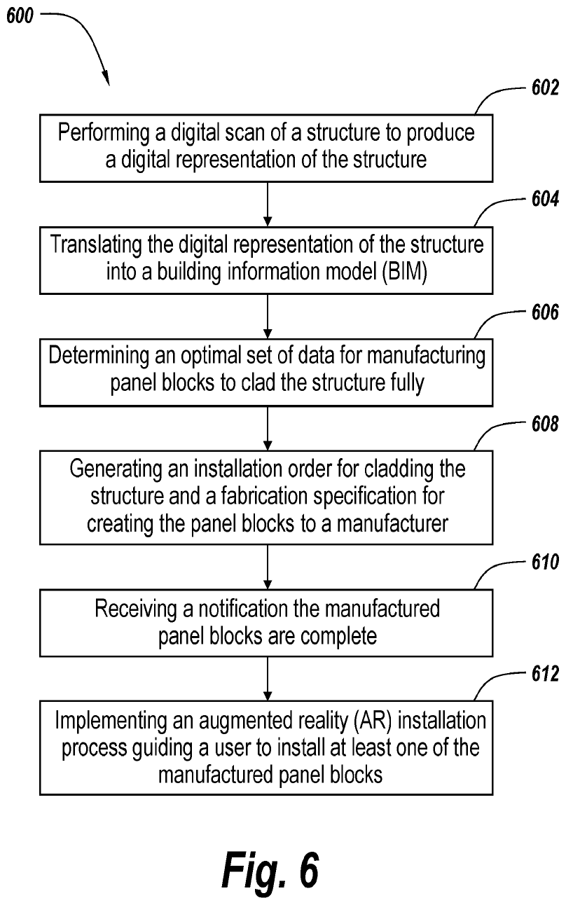

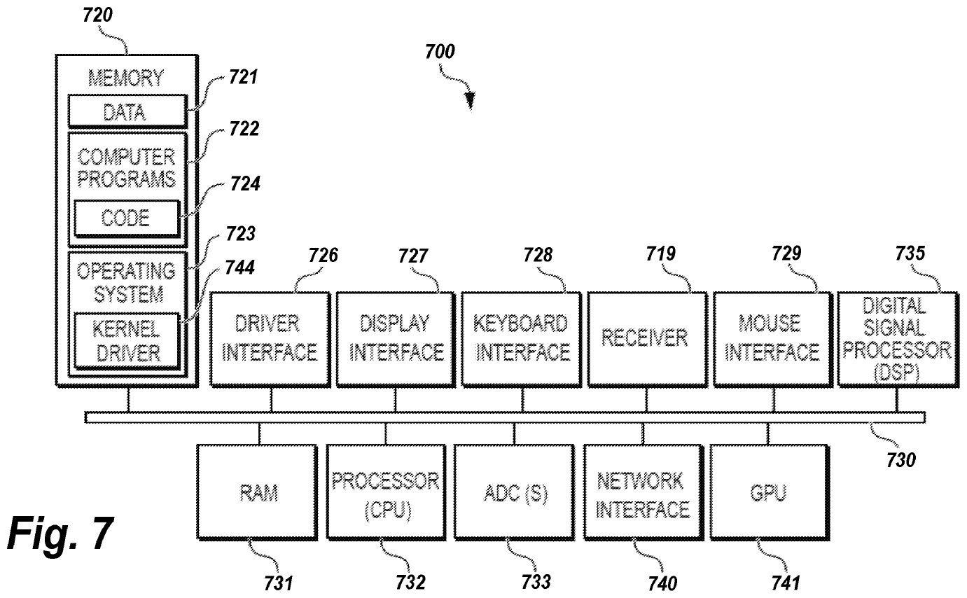

FIG. 6 is a flowchart of an installation process 600 of the panel blocks, in accordance with some embodiments. The operations may be implemented using computer-executable instructions stored on one or more non-transitory machine-readable storage media. The instructions may be executed by one or more processing devices, such as the computing system 700, as described in FIG. 7, to implement the operations.

Installation process 600 includes performing a digital scan of a structure to produce a digital representation of the structure (Step 602). A digital representation of the structure is captured with commercially available three-dimensional (3D) scanning hardware or the like. Each 3D scanning generates millions of colored or uncolored points in 3D space that represent the local environment. Several of these scans are overlapped to form a complete picture of the scanning environment. Note the digital representation may be represented as point cloud data.

Installation process 600 includes translating the digital representation of the structure into a building information model (BIM) (Step 604). BIM has all the features to fully define the position, dimension, and orientation of all walls and penetrations (e.g.—doors, windows). The digital representation of the structure is defined as point cloud data. The point cloud data may be converted directly into the BIM by reducing the point cloud data into groups of data for spreadsheet analysis. The imported data groups may be reduced to two dimensions (e.g., x-y, or y-z, depending on the feature being analyzed), and then fit the data with one (or more) linear curve fits to find “break points” defining key building features such as corner posts and edges of doors and windows. The dimensions derived from the point-cloud data generally matched tape measurements to within + 1/16″ (some cases closer to +⅛″).

Installation process 600 includes determining, using the BIM model, an optimal set of data for manufacturing panel blocks to clad the structure fully (Step 606). The panel blocks may include panel blocks described herein. One may use a panelization tool to determine the optimal set of standard and custom panel blocks to fully clad each building wall and create a cut list of standard and custom panel blocks that need to be manufactured. The panelization tool may take into account several factors in the optimization procedure, including available panel block size(s); the number of panel blocks to install (affects labor time to install); efficiency of foam utilization (from foam cutting); edge length (potential leakage sites); aesthetics (where panel block transitions occur, e.g., always have a U-shaped panel block above and below a window and other wall penetrations); BIM dimensional uncertainty; etc. For example, one may use a linear programming multi-objective optimization algorithm to maximize material efficiency and minimize installed costs subjected to specific aesthetic requirements.

Installation process 600 includes generating, using the optimal set of data, an installation order for cladding the structure and a fabrication specification for creating the panel blocks to a manufacturer (Step 608). The panelization tool may assign a unique identifier for each panel block and generate the installation order for the panel blocks that maximize installation efficiency.

Installation process 600 includes receiving notification the manufactured panel blocks are complete (Step 610). Installation process 600 includes implementing, using the digital scan, the optimum set of data, and the installation order, an augmented reality (AR) installation process guiding a user to install at least one of the manufactured panel blocks. In this case, an AR tool guides the installer through the installation process (Step 612). The AR tool has an immersive heads-up display that displays 3D holograms that the operator perceives to be in the real world. The AR installation process applies to any/all mixed reality hardware that displays holograms in the wearer's field of view while keeping their hands free.

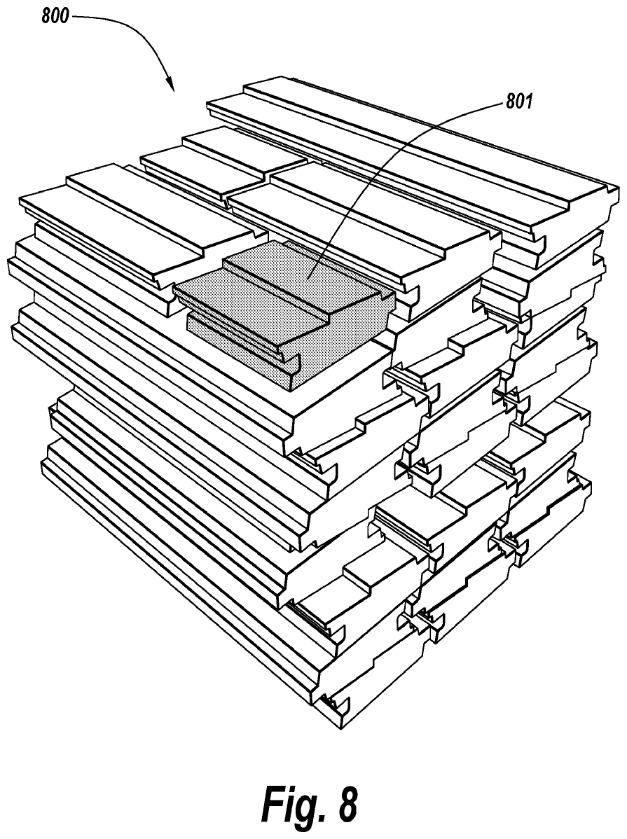

The structure's digital representation, the optimal data set, and the installation order drive the AR experience. They create the basis for a 3D virtual world (digital twin) where the AR “knows” the component order, where they are staged 800, as shown in FIG. 8, and where they are installed. The virtual world is aligned with the real world with one or more anchor points-unique features/objects placed in the scene before the original scan and used during the installation. It knows where the installer is positioned in the real world by mapping the surroundings with onboard sensors (vision, lidar, etc.). The AR tool quality verifies that the correct component 801 was installed at the correct location by combining the unique identifier with its physical position in the real world. This data can also be saved for future evidence that the installation process was executed correctly.

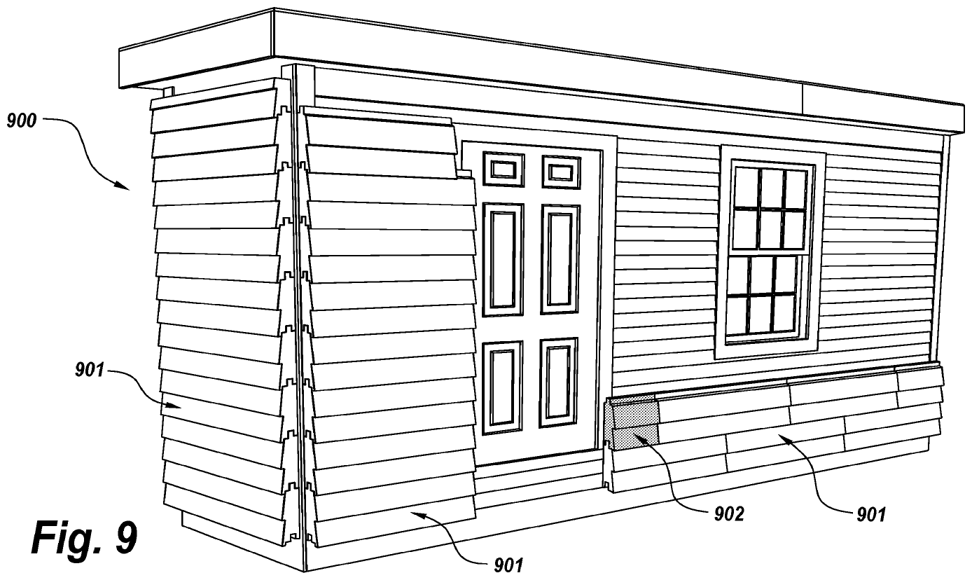

Installers may work in pairs, one who wears the AR headset to retrieve and place panel blocks, the other who attach the panel blocks into place using a power drill and 4-inch screws, for example. Based on a voice request, or other signal from the installer wearing the AR heads-up display, the AR experience projects a 3D hologram of the next panel block (or trim piece) 902 to install in the worker's field of view of the shipping pallet and, upon receiving a second voice command or signal, projects where to install it on the façade 901 of structure 900, as shown in FIG. 9. Thus, the AR experience empowers workers, reducing installation time and ensuring installation accuracy.

FIG. 7 is a schematic diagram of a computing system 700 for executing the operations of the installation process 600, in accordance with some embodiments. As shown in FIG. 7, computing system 700 includes memory 720, which may include a non-transitory computer-readable medium such as a computer hard disk. Memory 720 stores data 721, computer programs 722, and operating system 723, among other things. In this case, operating system 723 may include a driver, for example a kernel driver 744, for controlling the operations of computer system 700. Among the computer programs stored in memory 720 is computer code 724 associated with installation process 600 and the AR tool. Also included in computing system 700 are drive interface 726, display interface 727, keyboard interface 728, mouse interface 729, one or more computer buses 730, random access memory (RAM) 731, processor (CPU) 732, and graphic processing unit (GPU) 741. The computer system 700 may include a display that works in conjunction with display interface 727, and a keyboard that works in conjunction with keyboard interface 728 for inputting text and user commands. Also, the computer system 700 may include a mouse that works in conjunction with mouse interface 729 for positioning a cursor on display screen and for inputting user commands. The display interface 727 may work with an AR display-headset in rendering images or animations.

In some embodiments, memory 720 may contain multiple memory components for storing data. In some embodiments, RAM 731 may contain multiple RAMs for processing computer instructions.

Processor 732 may be a microprocessor, programmable logic, or the like for executing computer programs, such those noted above, out of RAM 731. Processor 732 accesses computer programs (or other data) stored on an external device via drive interface 726. GPU 741 is a type of processing device. For example, the GPU 741 may be a programmable logic chip that is configured to implement and to control display functionality. To this end, a GPU 741 may be programmed to render images, animation, and video on the computer's screen. The GPU may be used to display images or animation to an AR display headset. The GPU 741 may be located on a plug-in card or in a chipset on the motherboard of the computing system, or the GPU 741 may be in the same physical chip as the CPU 732. In some implementations, the CPU 732 may contain multiple CPUs. The multiple CPUs may be configured for parallel computing, in some embodiments.

The computer system 700 may have a receiver 719, e.g., a radio receiver, to receive and/or transmit information wirelessly or the like. Computing system 700 may also include one or more analog to digital converters (ADC) 733 to convert incoming analog RF signals from receiver 719 to digital samples. The computing system 700 may also include a digital signal processor (DSP) 735 to perform digital signal processing operations on the digital samples. The DSP 735 may also be operated to improve the quality of the digital samples. The DSP may also be capable of executing computer programs that do not relate to signal processing.

Computing system 700 includes a network interface 740, such as an Ethernet port, for interfacing to a network, such as the Internet. In some embodiments, computing system 700 may be a server connected to multiple computing systems 700.

In some implementations, multiple electronic components, such as the GPU 741, the CPU 732, and/or the DSP 735, may execute one or more computer programs concurrently or contemporaneously. In some implementations, the GPU 741 may contain multiple components of each type shown in FIG. 7; for example, multiple CPUs, multiple GPUs, multiple DSPs, and so forth. One or more of each type of component may be configured to execute one or more computer programs concurrently, contemporaneously, or simultaneously.

The disclosure describes panel blocks and an installation process for installing them. The advantages provided by the panel blocks include easy assembly of the panel blocks for retrofitting a structure. The panel blocks are configured to be interlocked with adjacent panel blocks using a tongue feature and a groove feature. Moreover, the installation process of the panel blocks is designed to assist installers using immersive augmented reality (AR). The installation process also utilizes scanning of a structure to be retrofitted and extracting relevant data used in customizing panel blocks for the structure.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A panel block for retrofitting a structure comprising:
a plurality of foam blocks for insulation, each of the foam blocks having a first feature and a second feature, wherein the first feature and the second feature are configured to interlock adjacent panel blocks; and
a protective cladding layer positioned on one of the foam blocks.

2. The panel block of claim 1, wherein the first feature comprises an inner flange and an outer flange.

3. The panel block of claim 2, wherein the second feature comprises an inner flange and an outer flange.

4. The panel block of claim 3, wherein the inner flange and the outer flange of the first feature interacts with the inner flange and the outer flange of the second feature of at least one of the adjacent panel blocks to form a seal when interlocked.

5. The panel block of claim 4, wherein the first feature provides mechanical support to the inner flange of the second feature of at least one of the adjacent panel blocks.

6. The panel block of claim 5, wherein the first feature is configured to receive a screw.

7. The panel block of claim 6, wherein the outer flange of the second feature of at least one of the adjacent blocks hides the screw from view.

8. The panel block of claim 7, wherein the inner flange and the outer flange of the first feature are asymmetric.

9. The panel block of claim 8, wherein the outer flange of the first feature is lower than the inner flange of the first feature.

10. The panel block of claim 1, wherein the protective cladding layer comprises vinyl.

11. The panel block of claim 1, wherein the protective cladding layer comprises a U-shape structure that clips on a protruding section of one of the foam blocks.

12. The panel block of claim 1, wherein the protective cladding layer comprises aluminum.

13. The panel block of claim 1, wherein the protective cladding layer comprises wood.

14. The panel block of claim 1, wherein the protective cladding layer comprises a synthetic material with the appearance of wood.

15. The panel block of claim 1, wherein the protective cladding layer comprises a moldable material.

16. The panel block of claim 15, wherein the moldable material comprises an appearance of bricks.

17. The panel block of claim 15, wherein the moldable material comprises an appearance of stones.

18. The panel block of claim 15, wherein the moldable material comprises an appearance of stucco.

19. The panel block of claim 1, wherein the protective cladding layer is comprised of a stucco.

20. The panel block of claim 1, wherein each of the foam blocks are arranged to be staggered relative to each other

21. A method for manufacturing a panel block, the method comprising:
forming a plurality of foam blocks for insulation;
arranging each of the foam blocks to be positioned relative to each other, each of the foam blocks having a first feature and a second feature, wherein the first feature and the second feature are configured to interlock adjacent panel blocks; and
positioning a protective cladding layer on a surface of one of the foam blocks.

22. The method of claim 21, wherein the first feature comprises an inner flange and an outer flange.

23. The method of claim 22, wherein the second feature comprises an inner flange and an outer flange.

24. The method of claim 23, wherein the inner flange and the outer flange of the first feature interacts with the inner flange and the outer flange of the second feature of at least one of the adjacent panel blocks to form a seal when interlocked.

25. The method of claim 24, wherein the first feature provides mechanical support to the inner flange of the second feature of at least one of the adjacent panel blocks.

26. The method of claim 25, wherein the first feature is configured to receive a screw.

27. The method of claim 26, wherein the outer flange of the second feature of at least one of the adjacent blocks hides the screw from view.

28. The method of claim 27, wherein the inner flange and the outer flange of the first feature are asymmetric.

29. The method of claim 28, wherein the outer flange of the first feature is lower than the inner flange of the first feature.

30. The method of claim 21, wherein the protective cladding layer comprises vinyl.

31. The method of claim 21, wherein the protective cladding layer comprises a U-shape structure that clips on a protruding section of one of the foam blocks.

32. The method of claim 21, wherein the protective cladding layer comprises aluminum.

33. The method of claim 21, wherein the protective cladding layer comprises wood.

34. The method of claim 21, wherein the protective cladding layer comprises a synthetic material with the appearance of wood.

35. The method of claim 21, wherein the protective cladding layer comprises a moldable material.

36. The method of claim 35, wherein the moldable material comprises an appearance of bricks.

37. The method of claim 35, wherein the moldable material comprises an appearance of stones.

38. The method of claim 35, wherein the moldable material comprises an appearance of stucco.

39. The method of claim 21, wherein the protective cladding layer is comprised of a stucco.

40. The method of claim 21, wherein each of the foam blocks are arranged to be staggered relative to each other

41. A method for installing panel blocks, the method comprising
performing a digital scan of a structure to produce a digital representation of the structure;
translating the digital representation of the structure into a building information model (BIM);
determining, using the BIM model, an optimal set of data for each of the panel blocks to clad the structure;
generating, using the optimal set of data, an installation order for cladding the structure and a fabrication specification for creating the panel blocks to a manufacturer; and
implementing, using the digital scan, the optimum set of data, and the installation order, an augmented reality (AR) installation process guiding a user to install at least one of the manufactured panel blocks.

42. The method of claim 41, wherein the digital scan comprises a scanned three-dimensional image of the structure.

43. The method of claim 41, wherein the digital representation is point cloud data.

44. The method of claim 41, wherein the BIM comprises position, dimension, and orientation of the structure.

45. The method of claim 43, wherein translating the digital representation of the structure comprises converting the point cloud data into the BMI.

46. The method of claim 41, wherein determining the optimal set of data comprises utilizing a panelization tool to determine the optimal set of standard and custom panel blocks to fully clad the structure.

47. The method of claim 46, wherein utilizing the panelization tool comprises creating a cut list of standard and custom panel blocks that need to be manufactured.

48. The method of claim 41, wherein determining the optimal set of data comprises utilizing a linear programming multi-objective optimization algorithm to maximize material efficiency and minimize installed costs subjected to specific aesthetic requirements.

49. The method of claim 41, wherein generating the installation order comprises assigning a unique identifier for each of the panel blocks and generating the installation order for the panel blocks that maximize installation efficiency.

50. The method of claim 41, wherein implementing the AR installation process comprises utilizing an AR tool to guide an installer through the installation process.

51. The method of claim 50, wherein the AR tool comprises an immersive heads-up display that projects 3D holograms that an operator perceives to be in the real world.

52. A system for installing panel blocks, the system comprising:
one or more computing device processors; and
one or more computing device memories, coupled to the one or more computing device processors, the one or more computing device memories storing instructions executed by the one or more computing device processors, wherein the instructions are configured to:
perform a digital scan of a structure to produce a digital representation of the structure;
translate the digital representation of the structure into a building information model (BIM);
determine, using the BIM model, an optimal set of data for each of the panel blocks to clad the structure;
determine, using the BIM model, an installation order
generating, using the optimal set of data, an installation order for cladding the structure and a fabrication specification for creating the panel blocks to a manufacturer; and
implement, using the digital scan, the optimum set of data, and the installation order, an augmented reality (AR) installation process guiding a user to install at least one of the manufactured panel blocks.

53. The system of claim 52, wherein the digital scan comprises a scanned three-dimensional image of the structure.

54. The system of claim 52, wherein the digital representation is point cloud data.

55. The system of claim 52, wherein the BIM comprises position, dimension, and orientation of the structure.

56. The system of claim 54, wherein while translating the digital representation of the structure, the instructions are configured to convert the point cloud data into the BMI.

57. The system of claim 52, wherein while determining the optimal set of data, the instructions are configured to utilize a panelization tool to determine the optimal set of standard and custom panel blocks to fully clad the structure.

58. The system of claim 57, wherein while utilizing the panelization tool, the instructions are configured to create a cut list of standard and custom panel blocks that need to be manufactured.

59. The system of claim 52, wherein while determining the optimal set of data, the instructions are configured to utilize a linear programming multi-objective optimization algorithm to maximize material efficiency and minimize installed costs subjected to specific aesthetic requirements.

60. The system of claim 52, wherein while generating the installation order, the instructions are configured to assign a unique identifier for each of the panel blocks and generating the installation order for the panel blocks that maximize installation efficiency.

61. The system of claim 52, wherein while implementing the AR installation process, the instructions are configured to utilize an AR tool to guide an installer through the installation process.

62. The system of claim 52, wherein the AR tool comprises an immersive heads-up display that projects 3D holograms that an operator perceives to be in the real world.

63. A non-transitory computer-readable storage medium storing instructions which when executed by a computer cause the computer to perform a method for installing panel blocks, the method comprising:
performing a digital scan of a structure to produce a digital representation of the structure;
translating the digital representation of the structure into a building information model (BIM);
determining, using the BIM model, an optimal set of data for each of the panel blocks to clad the structure;
generating, using the optimal set of data, a fabrication specification and an installation order for creating the panel blocks to a manufacturer; and
implementing, using the digital scan, the optimum set of data, and the installation order, an augmented reality (AR) installation process guiding a user to install at least one of the manufactured panel blocks.
